(19) United States
(12) Patent Application Publication
(10) Pub. No.: US 2023/0391558 A1
(43) Pub. Date: Dec. 7, 2023

(54) CONVEYING SYSTEM HAVING PRODUCT DISPENSING MONITORING

(71) Applicant: Ferag AG, Hinwil (CH)

(72) Inventor: Markus Bretz, Herrliberg (CH)

(21) Appl. No.: 18/326,358

(22) Filed: May 31, 2023

(30) Foreign Application Priority Data
Jun. 1, 2022 (CH) 000664/2022

(51) Int. Cl. B65G 43/08; B65G 47/38; B65G 47/46

(52) U.S. Cl. CPC B65G 43/08; B65G 47/38; B65G 47/46; B65G 2203/0233; B65G 2203/044; B65G 2203/025

(57) ABSTRACT

A conveyor system for conveying and delivering conveyed goods and including a tray conveyor having a plurality of conveyor trays displaceable along a conveyor track. The conveyor trays each include at least one conveyor tray element. The system further includes at least one sensor device disposed along the conveyor track of the conveyor trays for detecting conveyed goods. The at least one conveyor tray element has at least one pass-through opening. The sensor device is implemented and disposed such that a measuring beam path of the sensor device is aimed through the at least one pass-through opening on the at least one conveyor tray element in a defined conveying position of the at least one conveyor tray element.

### BACKGROUND OF THE INVENTION

### Field of the Invention

The invention is in the field of conveying and sorting technology and relates to a conveyor system having a tray conveyor for conveying and delivering conveyed goods, also called conveyed materials. The tray conveyor includes a plurality of conveyor trays displaceable, i.e. moveable along a conveyor track, the conveyor trays each including at least one conveyor tray element. The conveyor system further includes at least one sensor device disposed along the conveyor track of the conveyor trays for detecting conveyed goods.

### Description of the Related Art

Conveyor systems of the type according to the invention are particularly used for sorting goods conveyed along a conveyor track according to defined criteria by delivering, also called dispensing, the conveyed goods at various delivery stations disposed along the conveyor track.

Sorting conveyors are thus known, according to which the conveyed goods are conveyed in tippable conveyor trays known as tipping trays along a conveyor track past delivery stations, also called dispensing stations. The tippable conveyor trays include pivotable side walls for pivoting or folding down for delivering the conveyed goods. The conveyed good is delivered when the side wall on the delivery side is pivoted down by sliding from the conveyor tray tilted toward the delivery side to the delivery station under the influence of gravity. The conveyed good thereby slips or slides down the side wall pivoted down at the delivery station and is delivered to a transfer device, i.e. takeover device.

The publication CH 710 851 A1 discloses a sorting conveyor indicated above having tipping trays including pivotable side walls for delivering the conveyed goods.

For trouble-free conveying and sorting operation, it is important that the conveying of the conveyed goods, particularly the delivering of the conveyed goods at a delivery station, is monitored and tracked by corresponding sensor devices.

It is known, for example, that delivering the conveyed goods at a delivery station is monitored in order to determine whether a conveyed good has actually been delivered or conveyed onward. Sensor devices are further also used for detecting the presence of conveyed goods in the conveyor trays at a defined conveying position along the conveyor track and/or for identifying the conveyed goods in the conveyor trays.

The sensor devices known from the prior art, such as RFID reading devices, are typically complex, however, and therefore procurement is expensive and operation and maintenance are costly. The more complex the sensor devices, the more typically susceptible said devices are to faults and erroneous measurements. Furthermore, the sensor device often takes up a large amount of space in the conveyor system and severely limits the flexibility of setup and operation of the conveyor system.

### SUMMARY OF THE INVENTION

The object of the present invention is therefore to propose a conveyor system having a sensor device for detecting the presence of a conveyed material, said system being simple in setup, compact, robust, and inexpensive for procurement and operation. The sensor device should further take up as little space as possible and ensure high flexibility with respect to setup and operation of the conveyor system.

A further object is to propose a corresponding sensor device for detecting conveyed goods delivered at a delivery station.

An object of the present invention is particularly the targeted delivering of conveyed goods at delivery stations. That is, the effective delivering of conveyed goods is to be detected by corresponding sensor means.

A further object is to propose a corresponding sensor device for detecting conveyed goods conveyed in a conveyor tray.

A further object is to propose a corresponding sensor device for detecting conveyed goods incorrectly positioned on the tray conveyor.

The conveyor system for conveying and delivering conveyed goods includes a tray conveyor having a plurality of conveyor trays displaceable, i.e. moveable along a conveyor track, the conveyor trays each including at least one conveyor tray element. The conveyor system further includes a sensor device disposed along the conveyor track of the conveyor trays for detecting conveyed goods.

The invention is characterized in that the at least one conveyor tray element includes at least one pass-through region, particularly for passing through a measuring beam, and the sensor device is implemented, i.e. designed and disposed, i.e. arranged such that a measuring beam path of the sensor device is aimed through the at least one pass-through region on the at least one conveyor tray element in a defined conveying position of the at least one conveyor tray element along the conveyor track.

In particular, the conveyor tray element forms a support surface for the conveyed goods.

The measuring beam path describes the geometric path of a measuring beam emitted by the sensor device. The measuring beam path is particularly linear.

The measuring beam path is directed in particular from below, and specially from vertically below, against the at least one pass-through region on the at least one conveyor tray element. The measuring beam path can, for example, be directed vertically from below or obliquely from below against the at least one pass-through region on the at least one conveyor tray element.

In particular, the measuring beam path runs parallel to the surface normal of the conveyor tray element through whose pass-through region the measuring beam path is directed.

In particular, the measuring beam path runs essentially transverse to the conveying direction. In particular, the measuring beam path runs perpendicular to the conveying direction.

The sensor device particularly includes at least one sensor unit for generating and detecting a measuring beam. The sensor unit particularly includes a transmitter for emitting a measuring beam. The sensor unit particularly includes a receiver or sensor for receiving a measurement signal. The measurement signal is particularly induced by the measuring beam. The measurement signal is particularly an at least partially reflected measuring beam.

The receiver and transmitter of the sensor unit can be mounted in a common physical unit, such as in a housing. The transmitter and receiver can also be spatially separated from each other and mounted in different physical units, such as in different housings.

The sensor device or the at least one sensor unit of the sensor device is particularly stationary.

The conveyor trays are accordingly displaced, i.e. moved, along the conveyor track past the sensor device, i.e. past the at least one sensor unit of the sensor device, wherein the at least one pass-through region is displaced along the conveyor track through the measuring beam path of the sensor device or of the at least one sensor unit in a defined conveying position or along a defined conveyor track segment of the conveyor tray, depending on the embodiment of the pass-through region.

The sensor device is particularly implemented or designed for detecting a covering, by a conveyed material, of the measuring beam path or the measuring beam leading through the at least one pass-through region in the at least one conveyor tray element. In other words, the sensor device can detect a conveyed good at least partially covering the at least one pass-through region.

The measuring procedure takes place in a measurement interval in each case, wherein the at least one pass-through region is displaced through the measuring beam path or measuring beam of the sensor device or the at least one sensor unit. The measurement interval is accordingly synchronized by the control device to the motion of the conveyor trays or of the at least one pass-through region, i.e. to the cycle of the conveyor trays along the conveyor track. In this manner, it is ensured that a measuring procedure takes place only when the at least one pass-through region is displaced through the measuring beam path or measuring beam of the sensor device or of the at least one sensor unit. Otherwise, the sensor unit would also detect the wall of the conveyor tray element, leading to false results.

The at least conveyor tray element can include a plurality of pass-through regions, particularly pass-through openings, spaced apart from each other.

A plurality of pass-through regions can be disposed successively in the conveying direction, i.e. along the conveyor track.

A plurality of pass-through regions can be disposed, for example, one after the other and in a row in the conveying direction, i.e. along the conveyor track. This has the advantage that for a plurality of pass-through regions passing through the measuring beam path of the sensor unit, successive measurement intervals can be performed and thus detecting can occur over a larger conveyor path segment.

A plurality of pass-through regions can also, however, be disposed successively in the conveying direction, i.e. along the conveyor track but also particularly laterally offset to each other in the delivery direction of the conveyed material. The lateral offset of the pass-through regions particularly considers the sliding parabola performed by the combined sliding and conveying motion of the conveyed good when delivering the conveyed good during the measurement intervals.

As mentioned, it can be provided that a plurality of pass-through regions of the at least one conveyor tray element cross through the measuring beam path or measuring beam of the sensor device, i.e. of the at least one sensor unit of the sensor device. The detecting of the conveyed good can accordingly take place over a plurality of measurement intervals, wherein one measurement interval is coupled in each case to one pass-through region crossing through the measuring beam path.

It is possible that the pass-through regions or pass-through openings in the at least one conveyor tray element implement a hole pattern, particularly a regular hole pattern, particularly over the entire surface of the at least one conveyor tray element.

The at least one conveyor tray element is very particularly flat, particularly implemented in a plate-like manner. The pass-through region can also correspond to the flat or plate-like conveyor tray element.

The at least one conveyor tray element is particularly implemented in a wall-like manner and the at least one pass-through region is disposed in the wall surface, i.e. wall area of the at least one conveyor tray element. The pass-through region can also itself implement, i.e. form the wall surface or the wall-like conveyor tray element.

The at least one pass-through region, however, is particularly a pass-through opening in the conveyor tray element. The pass-through opening is characterized in that said opening is fully surrounded and comprised by the conveyor tray element.

The at least one pass-through opening can be implemented or designed as a window.

If the measuring beam is electromagnetic radiation in the visible range, such as light, then the pass-through region can be made of a transparent or translucent material such as glass or plastic, for example acrylic glass. A pass-through region implemented or designed as a window in the present case is particularly a viewing window. The viewing window is also particularly implemented by a transparent or translucent material, such as glass or plastic, for example acrylic glass. The glass can be a scratch-proof, hardened glass or a sapphire glass.

The at least one pass-through opening can, however, also be implemented as a penetration, i.e. aperture or as a passage opening or passage hole.

The at least one pass-through opening is particularly elongated in design. The length of the pass-through opening is particularly at least twice as large as the width thereof The longitudinal axis of the elongated pass-through opening particularly runs parallel to the conveying direction. The pass-through opening is thereby displaced through the measuring beam path or measuring beam of the sensor device or of the at least one sensor unit along a conveyor track segment corresponding to the longitudinal extent of the pass-through opening. This allows a longer measurement interval. A pass-through opening the form of a penetration, i.e. aperture can be an elongated hole in the present case, for example.

A measuring beam is emitted by the transmitter of the sensor device, i.e. the sensor unit for detecting the covering, by a conveyed material, of the pass-through region, i.e. of the measuring beam path or the measuring beam. Said measuring beam, as explained above, is timed to match the motion of the pass-through region along the conveyor track, so that the measuring beam is aimed through the pass-through region being displaced, i.e. moved past the sensor device, i.e. past the at least one sensor unit, particularly passing above the sensor device, i.e. the at least one sensor unit.

When the pass-through region, i.e. the measuring beam path or measuring beam is covered by a conveyed material, the measuring beam is at least partially reflected at the conveyed material. A receiver of the sensor device, i.e. of the at least one sensor unit detects the measuring beam at least partially reflected back through the pass-through region.

The at least one sensor unit is particularly an optoelectronic sensor unit. The at least one sensor unit is particularly a laser sensor unit.

The measuring beam is particularly a light beam. In the present case, the transmitter is a light source. The measuring beam or light beam is particularly from the visible electromagnetic spectrum. The light beam is particularly a laser beam. The light beam can, however, also be infrared light or UV light. A laser beam has the advantage, however, that said beam is very focused and thereby allows very precise measuring, even through a comparatively small pass-through region.

The at least one sensor unit is particularly a reflective light sensor. Reflective light sensors detect objects by capturing a measuring beam reflected at the object.

The sensor device can include a plurality of sensor units spaced apart from each other, particularly a plurality of optoelectronic sensor units, such as laser sensor units, the measuring beam paths thereof being disposed, i.e. arranged successively in the conveying direction.

The successive measuring beam paths of the sensor units in the conveying direction can be disposed, i.e. arranged in a row, one after the other. The measuring beam paths of the sensor units, successive in the conveying direction, can also be disposed, i.e. arranged laterally offset from each other, particularly in the delivery direction. Here again, the lateral offset particularly serves for considering the sliding parabola of the conveyed good mentioned above.

The sensor device can include a plurality of sensor units spaced apart from each other, particularly a plurality of optoelectronic sensor units, such as laser sensor units, the measuring beam paths thereof being disposed, i.e. arranged successively transverse to the conveying direction.

The successive measuring beam paths of the sensor units transverse to the conveying direction can be disposed in a row, one after the other. The successive measuring beam paths of the sensor units transverse to the conveying direction can also be disposed, i.e. arranged laterally offset from each other in the conveying direction.

A combination of the sensor arrangements indicated above is also possible, having measuring beam paths disposed, i.e. arranged successively in the conveying direction and disposed, i.e. arranged successively transverse to the conveying direction.

Further embodiments of sensor arrangements follow below in conjunction with the description of particular embodiments.

The conveyed good can be piece goods, such as a package or crate or a container. The conveyed good can, however, also be a bulk material, for example in the form of small parts or mass parts. Such small parts or mass parts can be screws, screw closures, blanks, etc., for example. The mass parts can be conveyed in containers on the conveyor trays.

The conveyor trays of the tray conveyor can be disposed, i.e. arranged on a conveyor chain or mounted on the same. The conveyor chain is particularly endless in design.

The conveyor chain particularly includes rollers for rolling along at least one guide rail. The at least one guide rail provides the conveyor track of the conveyor trays. The at least one guide rail implements, i.e. forms at least one rolling surface for the rollers. The at least one guide rail can implement a guide channel in which the rollers of the conveyor chain roll.

The conveyor trays implement, i.e. form conveyor units, optionally together with a tipping mechanism.

Due to the arrangement of the conveyor trays on a conveyor chain, the conveyor trays are uniformly and constantly spaced apart from each other during the conveying thereof. Furthermore, all conveyor units or conveyor trays are displaced along the conveyor track at the same conveying speed.

The conveyor trays each particularly include a receiving space for receiving a conveyed material.

The conveyor trays each include a conveyor tray floor, i.e. conveyor tray bottom, for example, whereon the conveyed good is supported. The conveyor tray floor bounds, i.e. delimits the receiving space at the bottom.

In particular, the measuring beam path is directed laterally from the conveyor tray bottom towards the at least one pass-through region on the at least one conveyor tray element.

The tray conveyor particularly implements a closed conveyor track. The tray conveyor particularly includes a drive for driving the conveyor trays.

The conveyor system can include along the conveyor track of the tray conveyor a delivery zone having at least one and particularly having a plurality of delivery stations disposed one after the other in the conveying direction for delivering the conveyed goods from the conveyor trays to a transfer device. The conveyed goods are delivered from the conveyor trays to a transfer device in a delivery direction at the delivery stations. The delivery direction particularly runs transverse to the conveying direction of the conveyed goods. The delivery of the conveyed goods at the delivery stations takes place particularly by lateral sliding of the conveyed goods from the previously tilted conveyor trays.

The transfer device can include collection or catchment containers. The transfer device can include a conveyor device such as a horizontal conveyor or linear conveyor for conveying the delivered conveyed goods away or onward. The transfer device can also include transport vehicles, such as automated guided transport vehicles or transport robots.

The conveyor system can include along the conveyor track of the tray conveyor a loading zone having at least one and particularly having a plurality of loading stations disposed one after the other in the conveying direction for loading the conveyor trays with conveyed goods. The at least one loading station is particularly disposed upstream of the delivery zone.

The conveyor system can include a capturing station at the at least one loading station and particularly downstream after the loading zone and before the delivery zone for capturing and identifying the goods conveyed on the conveyor trays. For traceability purposes, technical control means can be used by the capturing station for associating the conveyed goods with the conveyor trays on which said goods are conveyed.

The capturing station can include a read-out device for reading out an information carrier on the conveyed material, such as barcode, QR code, or RFID label, numerical code, or destination address.

The conveyor system further includes a control device. The control device serves, for example, for controlling the drive of the tray conveyor and the measurement interval of the measuring device. The control device can further also monitor the conveying of the conveyed goods on the basis of the information captured at the capturing station about the conveyed goods.

The conveyor system can particularly be a sorting system. Thus, the conveyed good can be delivered at a particular delivery station due to specific criteria, on the basis whereof the control device determines the delivery station at which the conveyed good is to be delivered. The pivoting down of a side wall of the conveyor tray for the purpose of delivering the conveyed good at the corresponding delivery station, for example, can be initiated accordingly by the control device.

Said criteria can be, for example, particular properties of the conveyed goods, such as size, weight, shape, color, type of conveyed material, or delivery address.

The delivering or sorting criteria can also be derived from the subsequent work steps to be performed on the conveyed goods, or from subsequent processes. The delivering or sorting criteria can also be derived from an allocation rule, for example, including uniform allocation of the conveyed goods to the various processing stations.

The tray conveyor is particularly a tipping tray conveyor, wherein the conveyor trays are implemented as tipping trays able to be tipped or tilted transverse to the conveying direction on at least one side for delivering the conveyed goods. The tipping trays can particularly be tipped or tilted transverse to the conveying direction toward a first delivery side, and toward a second delivery side opposite the first delivery side.

The tipping motion into a tipped position particularly brings about a tilting of the support surface or the conveyor tray floor of the tipping trays. The tipping motion takes place particularly due to a pivoting motion of the tipping tray about a pivot axis. The tipping axis or pivot axis is particularly parallel to the conveying direction.

The tipping trays can be operationally connected to a tilting mechanism. The tilting mechanism is particularly disposed between the conveyor chain and the tilting tray and connects the two to each other. The tipping mechanism is particularly part of a conveying unit.

The tipping trays are particularly displaced through the delivery zone in the tipped or tilted state. The tipping trays are accordingly tilted to one of the delivery sides when entering the delivery zone.

During conveying outside of the delivery zone, the tipping trays are particularly not tipped in a conveying position, that is, are particularly horizontally aligned. The tipping trays are accordingly pivoted back to the conveying position thereof when exiting the delivery zone.

The conveyor tray can include side walls for laterally bounding, i.e. delimiting, the receiving space. The conveyor tray can particularly include a first side wall and a second side wall opposite the same. The first and second side wall can be pivoted laterally downward from a retaining position into a delivery position, particularly transverse to the conveying direction toward a delivery side, for delivering the conveyed good at a delivery station.

A left side wall in the conveying direction can thus be pivoted laterally downward toward a left delivery side. A right side wall in the conveying direction can thus be pivoted laterally downward toward a right delivery side. Left and right side walls in the conveying direction can thus be pivoted laterally downward toward a left and right delivery side.

The pivotable side wall is particularly connected to the conveyor tray floor by a joint, such as a hinge. The pivotable side wall can, for example, be pivoted downward by a control mechanism. The pivoting upward of the side wall into the retaining position can also be done by a control mechanism, or by returning elements for pivoting the side wall back into the retaining position thereof by a returning force. The control mechanism can particularly be controlled by the control device.

The conveyor tray can include a locking mechanism for locking the pivotable side wall in the retaining position. The locking mechanism can particularly be released by the control mechanism and thus lead to the side wall pivoting downward. The pivotable side wall is particularly a pivotable flap.

The side wall pivoted downward particularly implements a lateral sliding surface for the conveyed good to be delivered at the delivery station.

The delivery station can implement a removal conveyor track for removing the conveyed goods sliding down from the conveyor tray. The side wall pivoted downward particularly spans between the conveyor tray floor tilted in the tipped position and the removal conveyor track of the delivery station. The removal conveyor track can be implemented, for example, by a particularly tilted sliding element, a conveyor belt, a roller conveyor, or a roller bed.

According to one embodiment, the tipping tray can be tipped prior to the at least one delivery station and can pass by the at least one delivery station in the tipped position. The delivering of the conveyed good at the delivery station takes place by pivoting downward the side wall on the delivery side from the retaining position into the delivery position.

According to a particular embodiment of the invention, the at least one conveyor tray element with the at least one pass-through region corresponds to a pivotable side wall, such as is described above. Said left and/or right side wall thus includes at least one pass-through region.

According to the present embodiment, the conveyor system includes at least one, particularly a plurality of delivery station(s) disposed along the conveyor track for delivering a conveyed good from the conveyor tray to a transfer device as described above.

The sensor device, i.e. the at least one sensor unit is disposed, i.e. arranged such that the measuring beam path of the sensor device at the delivery station is aimed in a defined measurement interval through the at least one pass-through region of the side wall of the conveyor tray pivoted downward at the delivery station for delivering the conveyed material.

The measuring beam path, i.e. the measuring beam is thereby aimed through the pass-through region particularly from below during the measurement interval. The measuring beam path runs particularly parallel to the surface normals of the side wall pivoted downward. The sensor device, i.e. the at least one sensor unit is accordingly disposed below the side wall pivoted downward at the delivery station.

The sensor device is implemented or designed for detecting an at least partial covering, by a conveyed good sliding downward, of the at least one pass-through region of the side wall pivoted downward at the delivery station.

The sensor device is particularly implemented or designed for detecting a covering, by a conveyed good sliding downward, of the measuring beam path, i.e. measuring beam leading through the at least one pass-through region of the side wall pivoted downward at the delivery station.

That is, the sensor device particularly detects an at least partial and particularly temporary covering of the at least one pass-through region by the conveyed good sliding downward from the conveyor tray to the delivery station or transfer device across the side wall pivoted downward.

It can be provided that the sensor device includes a plurality of sensor units, the measuring beam paths thereof being disposed successively in the conveying direction, particularly one after the other in a row. Such an arrangement particularly ensures capturing smaller conveyed goods sliding down from the conveyor tray at the delivery station.

It can be provided that the sensor device includes a plurality of sensor units, the measuring beam paths thereof being disposed successively transverse to the conveying direction, i.e. in the delivery direction, particularly disposed offset from each other in the conveying direction. Such an arrangement ensures capturing the sliding behavior, such as the sliding speed, of the conveyed good sliding down from the conveyor tray. For example, the sliding speed of the conveyed good can be determined from the time difference between detecting the conveyed good by two sensor units disposed one after the other.

Due to the sensor device, it can be detected by simple means whether a conveyed good has slid down from a conveyor tray and been transported to the transfer device, i.e. takeover device.

In a further development, the sensor device can include at least one control sensor unit. The control sensor unit is used to check whether a conveyed item has completely slipped off the conveyor tray. It can happen that conveyed goods become jammed and stuck during slipping, i.e. do not slip off completely. The control sensor unit is now intended to detect such goods that have become stuck or have not slipped off completely.

For this purpose, the control sensor unit is arranged at a point on the delivery station along the conveyor path of the tray conveyor at which the conveyed goods have already completely slipped off the conveyor tray. This point is, for example, especially at the exit of the delivery station. Alternatively, one control sensor unit can be provided for several delivery stations. In this case, the control sensor unit can be located, for example, at the exit of a delivery zone along the conveyor path of the tray conveyor in which the delivery stations are located.

In normal operation, the control sensor unit does not detect any conveyed goods, since these have already been discharged or slipped off the conveyor tray when the conveyor tray passes the measuring beam path of the control sensor unit. However, if the control sensor unit detects a conveyed good, it is a stuck conveyed good. After detection of a stuck conveyed good, the control unit can now initiate measures such as stopping the tray conveyor or notifying the operating personnel, e.g. by an optical or acoustic display.

The control sensor unit can have the same design as the at least one sensor unit of the sensor device described above.

The measuring beam path of the control sensor unit is directed in particular—analogously to at least one sensor unit of the sensor device—in a defined measuring interval through the at least one pass-through region of the downwardly pivoted side wall of the conveyor tray. However, it is also conceivable that the measuring beam path of the control sensor unit is directed through at least one pass-through region of the conveyor tray floor in a defined measuring interval.

The control sensor unit is designed analogously to the at least one sensor unit of the sensor device to detect a covering of the measuring beam path, i.e. measuring beam directed through the at least one pass-through region by a conveyed good.

The conveyed goods particularly include information carriers, such as labels having barcodes, QR codes, numerical codes, destination addresses, or RFID labels. The information carriers on the conveyed goods are typically read upstream prior to the delivery stations at a capturing station.

Furthermore, the conveying cycle of the conveyor trays filled with conveyed goods is typically tracked by the control device. This enables tracking the conveying of the conveyed goods along the conveyor track of the tray conveyor. The control device is particularly able to determine which conveyed good is conveyed in which conveyor tray, and where the conveyor tray is located at a particular point in time during conveying.

The control device is particularly also able to identify the conveyed good delivered at the associated delivery station solely by detecting, according to the invention, the delivering of a conveyed good from a conveyor tray.

Said information is significant, for example, when a conveyed good is released for delivering by tipping the conveyor tray and pivoting downward the side wall at a delivery station, but does not slide down due to increased friction or due to sticking or jamming on the conveyor tray and is therefore conveyed onward. The control device can continue to correctly track the associated conveyed material, despite the failed delivering, using the information that a conveyed good was not delivered, for example.

According to a further embodiment of the invention, the at least one conveyor tray element corresponds to the conveyor tray floor of the conveyor tray.

The sensor device is implemented or designed for detecting an at least partial covering, by a conveyed good present on the conveyor tray, of the at least one pass-through region in the conveyor tray floor.

The sensor device is particularly implemented or designed for detecting a covering, by a conveyed good present on the conveyor tray, of the measuring beam path, i.e. the measuring beam aimed through the at least one pass-through region in the conveyor tray floor.

The measuring beam path, i.e. the measuring beam is thereby aimed through the pass-through region particularly from below during the measurement interval. The sensor device, i.e. the at least one sensor unit is thereby particularly disposed below the conveyor tray passing by. The measuring beam path runs particularly parallel to the surface normal of the conveyor tray floor.

It can be provided that the sensor device includes a plurality of sensor units, the measuring beam paths thereof being disposed successively transverse to the conveying direction, particularly one after the other in a row. Such an arrangement particularly ensures capturing smaller conveyed goods disposed on the conveyor tray.

It is conceivable that the conveyor system according to the present embodiment includes at least one, particularly a plurality of delivery station(s) disposed, i.e. arranged, along the conveyor track for delivering a conveyed good from the conveyor tray to a transfer device, i.e. takeover device.

The sensor device, i.e. the at least one sensor unit is disposed, i.e. arranged in this case such that the measuring beam path of the sensor device at the delivery station is aimed in a defined measurement interval through the at least one pass-through region of the conveyor tray floor.

The measuring beam path or the measuring beam is thereby aimed through the pass-through region, such as aperture from below during the measurement interval. The sensor device or the at least one sensor unit is accordingly disposed below the conveyor tray floor at the delivery station.

The sensor device is thus implemented or designed for detecting a covering or a lack of covering of the measuring beam path i.e. the measuring beam aimed through the at least one pass-through region in the conveyor tray floor at the delivery station. That is, the sensor device particularly detects whether a conveyed good is present on the conveyor tray floor or not at the delivery station.

It can be derived from said information, for example, whether the conveyed good has been delivered or not. The measurement interval accordingly takes place subsequently at a delivery time window. The measurement interval can still take place, for example, when the conveyor tray is tilted or tipped. The measurement interval can take place, for example, after passing the at least one delivery station. The sensor device or the at least one sensor unit is accordingly disposed downstream of the at least one delivery station.

Pass-through regions are thus disposed particularly in the two edge regions of the conveyor tray floor opposite each other, each disposed toward one delivery side. Because the conveyed goods slide toward one of the two side walls when the tilted position is assumed, depending on the direction of tilting, the pass-through regions on the edge sides are at least partially covered by conveyed good and such is also detected during delivering.

A measurement interval can fundamentally take place before, during and/or after delivering of the conveyed good or subsequently to the delivery time window, or even subsequently to the delivery zone.

It can be provided that the sensor device includes a plurality of sensor units, the measuring beam paths thereof being disposed successively in the conveying direction, particularly one after the other in a row. Such an arrangement particularly ensures capturing smaller conveyed goods disposed on the conveyor tray floor.

It can be provided that the sensor device includes a plurality of sensor units, the measuring beam paths thereof being disposed successively transverse to the conveying direction, i.e. in the delivery direction, particularly disposed offset from each other in the conveying direction.

Such an arrangement ensures capturing the sliding behavior, such as the sliding speed, of the conveyed good sliding down from the conveyor tray. For example, the sliding speed of the conveyed good from the conveyor tray floor can be determined from the time difference between detecting the conveyed good by two sensor units disposed one after the other.

It is also conceivable that only the presence of a conveyed good on the conveyor tray is detected by the sensor device. In this case, the sensor device, i.e. the at least one sensor unit can be disposed downstream of the loading zone and particularly prior to the delivery zone.

Regarding identifying the delivered conveyed goods by the control device, the statements made above in conjunction with the pivotable side wall also apply here.

According to a further embodiment of the invention, the at least one conveyor tray element corresponds to a cover element of a cover device for at least partially covering an intermediate space between two conveyor trays adjacent to each other along the conveyor track. The cover element is particularly plate-like in design or implemented as a plate element.

Two successive conveyor trays in the conveying direction are typically spaced apart from each other. That is, an intermediate space is typically implemented between two successive conveyor trays in the conveying direction.

According to the present embodiment, said intermediate space is thus at least partially and particularly fully covered by a covering device or by at least one cover element of the covering device. Such a covering device is disclosed, for example, in the Swiss patent application CH000324/2022.

The covering device can be particularly implemented or designed for compensating for the relative motions of the conveyor trays while maintaining an at least partial and particularly full covering of the intermediate space between two adjacent conveyor elements. Such relative motions occur, for example, at a change in direction of the conveyor track.

The covering device can be made of a plurality of parts and can particularly include at least one further element in addition to the at least one cover element, for example a further cover element. The parts, particularly two or more than two cover elements, can be connected to each other in an articulated manner.

The covering device can be mounted, particularly hinged, on a front bounding wall of the conveyor tray as seen in the conveying direction. The covering device can be mounted, particularly hinged, on a rear bounding wall of the conveyor tray as seen in the conveying direction.

The sensor device is implemented or designed for detecting a covering of the at least one pass-through region in the cover element by an incorrectly placed conveyed good or foreign object between two conveyor trays above the cover element.

The sensor device is implemented or designed for detecting a covering of the measuring beam path, i.e. measuring beam leading through the at least one pass-through region in the cover element by an incorrectly placed conveyed good or foreign object between two conveyor trays above the cover element.

A foreign object can be, for example, a machine component unintentionally entering the conveyor region of the conveyor system.

The measuring beam path, i.e. the measuring beam is thereby aimed through the at least one pass-through region particularly from below during the measurement interval. The sensor device, i.e the at least one sensor unit is thereby particularly disposed below the covering device passing by. The measuring beam path runs particularly parallel to the surface normal of the cover element.

The sensor device, i.e. the at least one sensor unit is particularly disposed downstream, after the loading zone. The sensor device, i.e. the at least one sensor unit is particularly disposed upstream of the delivery zone. Said device allows removing incorrectly placed conveyed goods or foreign objects prior to tipping or tilting the tipping trays and prior to conveying the conveyed goods through the delivery zone.

When an incorrectly placed conveyed good or a foreign object is detected, the conveyor system can be stopped, for example, and the incorrectly placed conveyed good or foreign object can be removed by the operating personnel. Damage to the conveyor system, such as can be caused by uncontrolled falling of the incorrectly placed conveyed good or foreign object from the tipping tray, can thereby be prevented.

It can be provided that the sensor device includes a plurality of sensor units, the measuring beam paths thereof being disposed successively transverse to the conveying direction, particularly in a row. Such an arrangement particularly ensures capturing smaller conveyed goods or foreign objects present on the at least one cover element or covering the same.

Some or all of the embodiments indicated above can also be implemented in combination with each other in the conveyor system.

The invention further relates to a method for detecting conveyed goods being conveyed by a conveyor system according to the invention, as described above.

The method is characterized in that the measuring beam of the sensor device is aimed through the at least one pass-through region of the at least one conveyor tray element in a defined measurement interval and detects an at least partial covering, by a conveyed material, of the pass-through region, i.e. a covering of the measuring beam.

When sliding of a conveyed good at a delivery station is to be detected, the conveyor tray loaded with the conveyed good is displaced along the delivery stations in the tipped position, wherein the side wall on the delivery side is pivoted downward to the height of the corresponding delivery station from a retaining position into a delivery position for delivering the conveyed material.

It is now determined by the sensor device whether a conveyed good at the delivery station has slid down from the conveyor tray to the transfer device across the side wall pivoted downward.

This is done by emitting a measuring beam passing through the at least one pass-through region of the side wall pivoted downward in a defined measurement interval. When a conveyed good is present over the at least one pass-through region at the measuring point in time, the measuring beam is at least partially reflected. The at least partially reflected measuring beam is received by a receiver and evaluated.

Said measurement interval takes place synchronously with the motion of the at least one pass-through region through the measuring beam path of the sensor device, i.e. the at least one sensor unit. That is, said measurement interval is matched to the conveying motion of the conveyor trays, i.e. the conveying cycle of the conveyor trays along the conveyor track.

The same also applies to those embodiments where the conveyor tray element having the at least one pass-through region corresponds to the conveyor tray floor or a cover element of a covering device.

The sorting conveyor according to the invention has the following advantages:
delivering of conveyed goods at the delivery stations can be detected by technically simple and correspondingly inexpensive sensor means;
the sensor means are robust and durable and less susceptible to failure;
the sensor means allow simple evaluation of the measurement signals;
the method for detecting the delivery is simple and therefore less susceptible to failure;
because the conveyed goods are typically identified uniquely by means of information carriers, and the conveying cycle of the conveyor trays conveying the conveyed goods is tracked by the control device, the conveyed goods delivered at defined delivery stations can also be identified by means of the method according to the invention.

### BRIEF DESCRIPTION OF THE DRAWINGS

The object of the invention is explained in further detail below using preferred embodiment examples shown in the attached figures. They show, schematically in each case:

FIG. 1: a plan view of a sorting conveyor;

FIG. 2: a perspective view of a conveyor unit;

FIG. 3: a view of a sorting system according to FIG. 1 in the conveying direction from the region of the delivery stations, having two conveyor units in each of a first and second tipped position according to one embodiment;

FIG. 4: a view of a sorting system according to FIG. 1 in the conveying direction from the region of the delivery stations, having two conveyor units in each of a first and second tipped position according to a further embodiment;

FIG. 5a: a side view of two conveyor trays of a further embodiment;

FIG. 5b: a plan view of the two conveyor trays according to FIG. 5a;

FIG. 6: a perspective view of a detail of a further embodiment of a conveyor unit;

FIG. 7: a perspective view of a detail of a further embodiment of a conveyor unit.

### DETAILED DESCRIPTION OF THE INVENTION

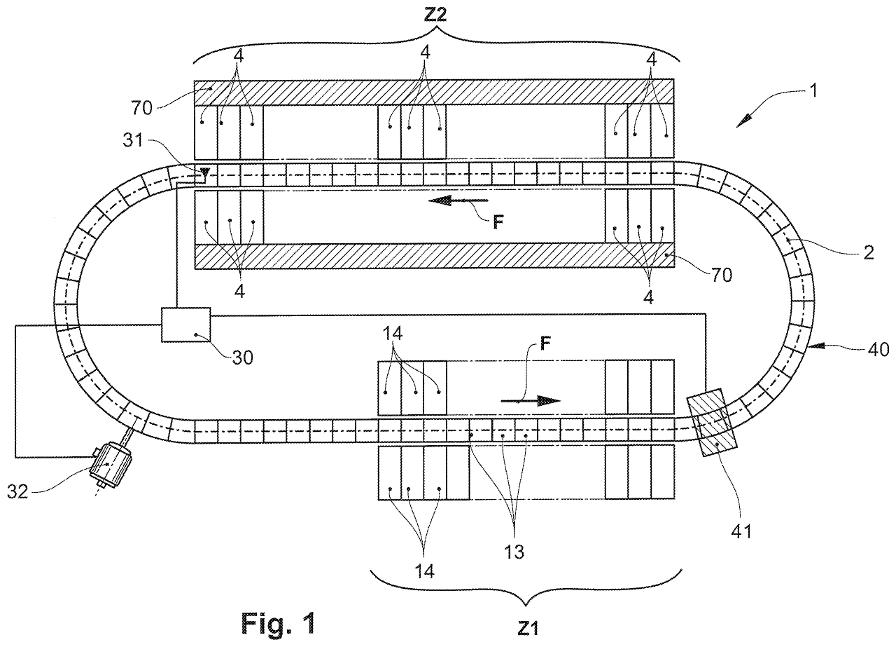

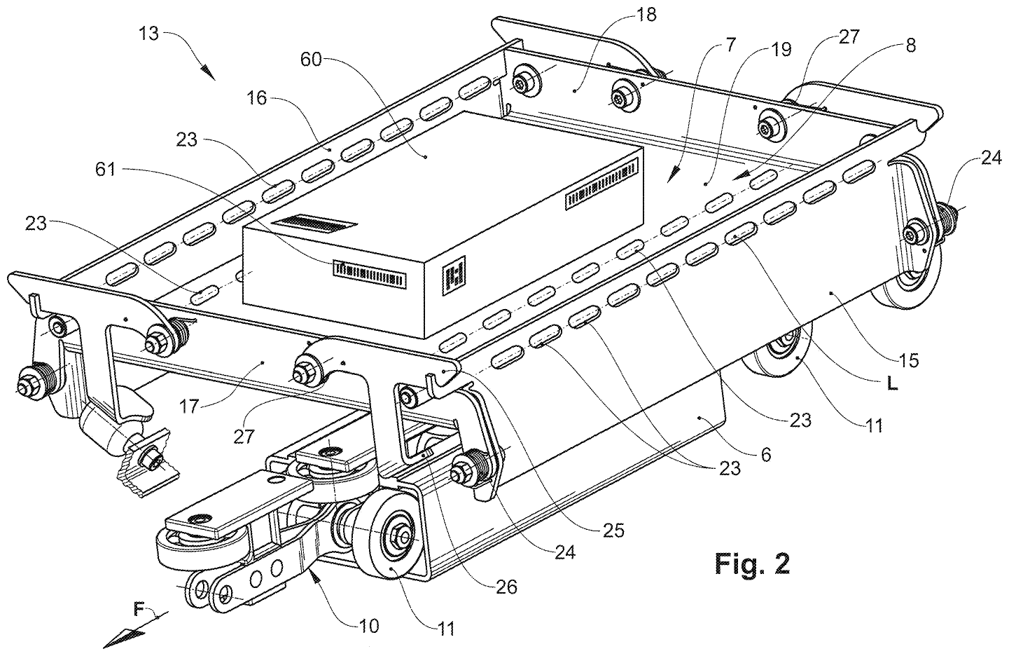

FIG. 1 shows a schematic depiction of a sorting conveyor 1. The sorting conveyor 1 implements a closed conveyor track 2, along which conveyor units 13 for loading with conveyed goods 60 and having tipping trays 7 can be displaced (see also FIG. 2).

The sorting conveyor 1 implements a loading zone Z1. The loading zone Z1 defines a conveyor track segment along which the conveyor units 13 are loaded with conveyed goods 60 by means of one or more loading stations 14.

The conveyor units 13 loaded with conveyed goods 60 are conveyed past a capturing station 41 in the conveying direction F, at which an information carrier 61 on the conveyed good 60 is read out for identification of the conveyed good 60. The data is transmitted to a control device 30. The conveyor units 13 are conveyed onward subsequent to the capturing station 41 into a delivery zone Z2, in which the conveyed goods 60 are delivered from the conveyor units 13 to a takeover device 70 at delivery stations 4 disposed successively along the conveyor track 2.

The sorting conveyor 1 includes delivery stations 4 disposed on both sides of the conveyor track 2 in the delivery zone Z2. This allows delivering of the conveyed goods toward two delivery sides.

To this end, the tipping trays 7 of the conveyor units 13 are displaced through the delivery zone Z2 in the tipped position. By assuming a tipped position of the tipping trays 7 when entering into the delivery zone Z2, it is already predetermined on which delivery side the conveyed good 60 will be delivered.

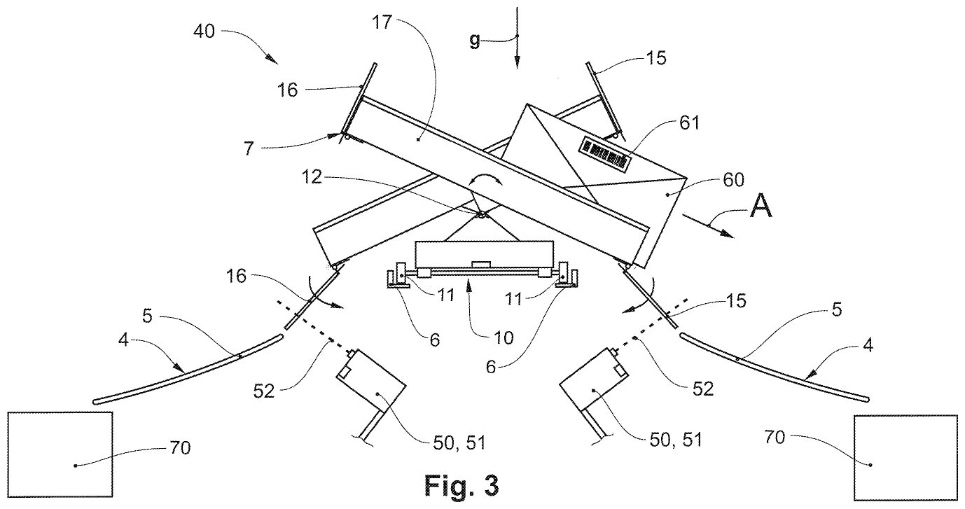

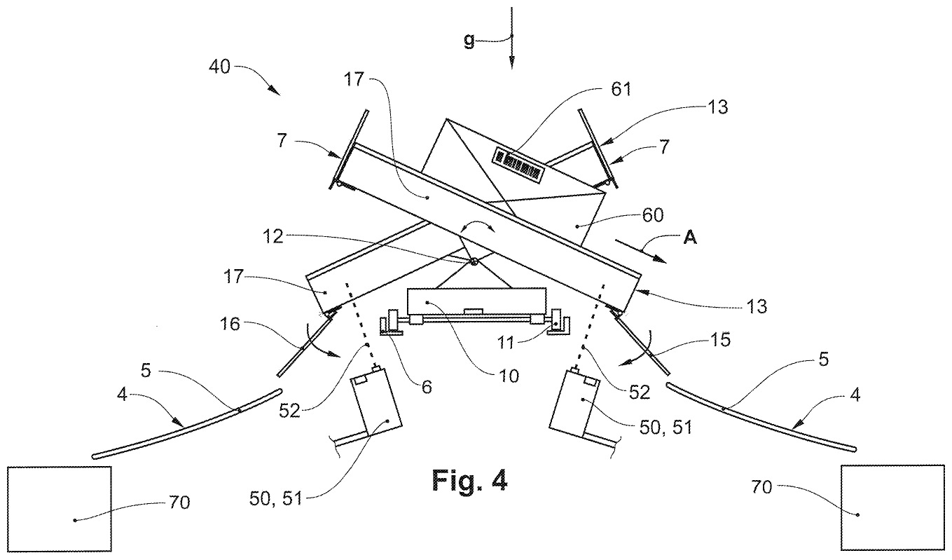

Because the tipping tray 60 is present along the delivery zone Z2 in the tipped position, the side wall 15, 16 of the tipping tray 7 on the delivery side need only be pivoted downward from a retaining position into a delivery position for delivering the conveyed good when passing the relevant delivery station 4 (see also FIGS. 3 and 4). This is done, for example, by a control element 31 associated with each delivery station 4. For clarity, only one control element 31 is sketched schematically in FIG. 1. The control element 31 can be a switching element for releasing a locking mechanism (see also FIGS. 3 and 4) for locking the side wall 15, 16. The control element 31 is controlled by the control device 30.

As soon as the corresponding side wall 15, 16 has been pivoted downward into the delivery position, the conveyed good 60 can slide down from the tilted tipping tray 7 toward the delivery station 4.

The conveyed good 60 is taken over by a takeover device 70 at the delivery station 4. After departing the delivery zone Z2, the tipping tray 7 is displaced back from the tipped position into the horizontal conveying position.

The conveyor units 13 are then displaced back into the loading zone Z1, where said units are again loaded with a conveyed good 60. A new conveying and sorting cycle thus begins.

Further stations can, of course, also be provided along the conveyor track 2 of the sorting conveyor 1, particularly between the loading zone and the delivery zone, such as a discharge station for discharging damaged or incorrectly placed conveyed goods 60 or foreign objects.

The sorting conveyor 1 is driven by a drive 32. The drive 32 is controlled by a the control device 30.

FIG. 2 shows an embodiment of a track-guided, i.e. rail-guided conveyor unit 13, such as can be used in a sorting conveyor 1 according to FIG. 1, for example.

The conveyor unit 13 includes a tippable conveyor tray 7 and a running carriage 10. The conveyor tray 7 is disposed on the running carriage 10 and connected thereto by a tipping mechanism 12 (see FIG. 3).

The tipping mechanism 12 allows tipping of the conveyor tray 7 relative to the running carriage 10 toward a first tipping side into a first tipped position and toward a second tipping side opposite the first tipping side into a second tipped position.

The conveyor tray 7 includes a conveyor tray floor 19 forming a support surface for a conveyed good 60. The conveyor tray floor 19 is enclosed by a first left and second right side wall 15, 16 as seen in the conveying direction F, and by a front and rear bounding wall 17, 18 as seen in the conveying direction F. The side and bounding walls 15-18 together with the conveyor tray floor 19 implement, i.e. form a receiving space 8 for the conveyed good 60. Furthermore, the side and bounding walls prevent the conveyed good 60 from sliding off the support surface.

The side walls 15, 16 are each correspondingly disposed toward one tipping side. The side walls 15, 16 can be pivoted between a conveying position, in which said walls prevent the conveyed good 60 from sliding off the support surface, into a delivery position, in which said walls expose a delivery opening for delivering the conveyed good 60 (see FIGS. 3 and 4).

The side walls 15, 16 are each pivotably supported about a pivot axis independently of each other. The side walls 15, 16 each interact with a pretensioned torsion spring 24 disposed in the pivot axis for exerting on the side walls 15, 16 a return force in the direction of the delivery position.

The side walls 15, 16 are retained in the locked position by a locking mechanism 25 in the conveying position, that is, when the side walls 15, 16 are pivoted upward. For pivoting the side walls 15, 16 downward, the locking of the locking mechanism 25 is released, whereby the side walls 15, 16 are autonomously pivoted into the delivery position due to the return force of the rotary spring 24, that is, are pivoted downward.

The releasing of the locking of the locking mechanism 25 takes place by the control element 31 actuating an actuating element 26 on the locking mechanism 25. The control element 31 can be switched on by the control device 30.

The locking mechanism 25 is connected to the conveyor tray 7 by a rotary joint connection. A pretensioned torsion spring 27 disposed in the rotary axis autonomously presses the locking mechanism 25 into the locking position. The control element 31 displaces the locking mechanism 25 opposite the return force of the torsion spring 27 out of the locking position when the actuating element 26 is actuated, so that the side wall 15, 16 can pivot downward.

The side walls 15, 16 implement a sliding surface for the conveyed good 60 in the delivery position.

For pivoting the side walls 15, 16 upward into the conveying position, said walls are folded up again by a control element (not shown) opposite the return force of the torsion spring 24. Said walls consequently catch in a latched position on the locking mechanism 25.

Other technical solutions for pivoting and locking the side walls 15, 16 between the conveying position and the delivery position are possible, of course.

The running carriage 10 includes rollers 11 for rolling along guide surfaces in a guide channel implemented by a guide rail 6. The guide rail 6 is disposed centered relative to the conveyor units 13. The running carriages 10 of the conveyor units 13 are each connected to each other by a hinged connection and thus form a chain of the conveyor units 13.

The side walls 15, 16 each include a series of elongated holes 23 disposed in a row one after the other as seen in the conveying direction F. The conveyor tray floor 19 also includes a row of elongated holes 23 disposed one after the other as seen in the conveying direction F. The function of said elongated holes 23 is explained in detail using FIGS. 3 and 4.

FIGS. 3 and 4 show sorting systems 1 such as is shown in FIG. 1, for example, each having a different arrangement of the sensor device, i.e. the sensor units 50, 51. The view is in the conveying direction F from the region of the delivery stations 4 and shows two conveyor units 13 each having a tipping tray 7 present in a first and opposite second tipping position toward the left and right side.

The conveyor units 13 each include a conveyor tray, i.e. tipping tray 7 and a running carriage 10 having rollers 11. The conveyor trays 7 are each connected to the running carriage 10 by a tipping mechanism 12. The tipping of the conveyor trays 7 takes place, for example, by a cam track, not shown here, making contact with a contact element on the conveyor tray 7 or the tipping mechanism 12.

The running carriage 10 and thus the conveyor unit 13 runs along a guide rail 6 by the rollers 11. The guide rail 6 correspondingly defines the conveyor track 2 of the conveyor units 13.

The two conveyor units 13 shown are disposed one after the other and are present at the height of a delivery station 4 disposed at the left and right side. The conveyor trays 7 of the conveyor units 13 are correspondingly tipped to the left and right sides in the conveying direction F.

The delivery stations 4 each include a tilted sliding element 5 implementing a sliding surface for the conveyed good 60 to be delivered. The side wall 15, 16 facing toward the delivery station 4 in each case is correspondingly pivoted downward toward the sliding element 5 and the inner wall surface thereof itself implements a sliding surface for adjoining to the sliding or slipping surface of the sliding element 5.

The conveyed good 60 thus slides at the delivery station 4 from the tilted conveyor tray 7 onto the sliding surface of the sliding element 5 under the influence of gravity across the side wall 15, 16 pivoted downward.

The side walls 15, 16 include penetrations 23, i.e. openings as shown in FIG. 2, for example.

An optoelectronic sensor unit 51 of a sensor device 50 is disposed below the conveyor tray 7, i.e. below the side wall 15, 16 pivoted downward. The measuring beam, i.e. the measuring beam path 52 thereof leads through a penetration 23, i.e. opening of the side wall 15, 16 pivoted downward in a defined measurement interval during a delivery time window.

The measurement interval is clocked or synchronized by the control device 30 to the motion of the conveyor trays 7 or of the at least one penetration 23, i.e. opening along the conveyor track 2, such that the measuring procedure takes place when the measuring beam path 52, i.e. the measuring beam of the sensor device 50, i.e. the sensor unit 51 is aimed through the penetration 23, i.e. opening of the side wall 15, 16 pivoted downward passing by in conveying direction F. The duration of the measurement interval is particularly matched to the span of time in which the measuring beam path 52 is aimed through the penetration 23 passing by at the conveying speed. For an elongated hole 23 aligned in the conveying direction F, said span of time is longer than for a round hole, for example.

The optoelectronic sensor unit 51 is a reflective light sensor. When the conveyed good 60 sliding down covers the penetration 23 and the measuring beam 52, the measuring beam 52 emitted by the transmitter of the sensor unit 51, such as a laser beam, is at least partially reflected through the penetration 23 by the conveyed good 60 and is received by the receiver of the sensor unit 51. The information that the conveyed good 60 has been delivered at the delivery station 4 is derived therefrom.

If, however, the penetration 23 and accordingly the measuring beam 52 is not covered by the conveyed good 60, then the measuring beam 52 aimed through the penetration is not reflected. The information that no conveyed good 60 has been delivered at the delivery station 4 is derived therefrom.

According to FIG. 2, a plurality of elongated holes 23 disposed one after the other in a row in the conveying direction F are disposed in the side wall 15, 16. The control device 30 can be implemented such that one measurement interval is triggered for each penetration 23, i.e. hole passing through the stationary measuring beam path 52. There are thus a plurality of successive measurement intervals during the delivery time window. The delivery of the conveyed good 60 can thus be monitored by the sensor device 50 over the duration of the delivery time window.

According to the embodiment according to FIG. 4, the conveyor tray floor 19 includes penetrations 23, i.e. openings or holes, at the side edge regions thereof facing toward the delivery sides, as are shown in FIG. 2, for example. Said side edge regions are typically not covered by the conveyed good 60 during conveying, but rather only when the conveyed good 60 is delivered.

An optoelectronic sensor unit 51 of a sensor device 50 is disposed below the conveyor tray 7. The measuring beam, i.e. the measuring beam path 52 thereof leads through a penetration 23, i.e. hole in the conveyor tray floor 19 in a defined measurement interval at the point in time of delivering.

The measurement interval is clocked or synchronized by the control device 30 to the motion of the conveyor trays 7 or of the penetration 23 along the conveyor track 2, such that the measuring procedure takes place when the penetration 23 in the conveyor tray floor 19 is displaced through the measuring beam path 52 of the sensor device 50, i.e. the sensor unit 51. The duration of the measurement interval is particularly matched to the span of time in which the measuring beam path 52 is aimed through the penetration 23 passing by at the conveying speed. For an elongated hole 23 aligned in the conveying direction F, said span of time is longer than for a round hole, for example.

The optoelectronic sensor unit 51 is a reflective light sensor. When the conveyed good 60 sliding down covers the penetration 23 or the measuring beam 52, the measuring beam 52 emitted by the transmitter of the sensor unit 51, such as a laser beam, is at least partially reflected through the penetration 23 by the conveyed good 60 and is received by a receiver of the sensor unit 51. The information that the conveyed good 60 has been delivered at the delivery station 4 is derived therefrom.

If, however, the penetration 23 and the measuring beam 52 is not covered by the conveyed good 60, then the measuring beam 52 aimed through the penetration 23 is not reflected. The information that no conveyed good 60 has been delivered at the delivery station 4 is derived therefrom.

According to FIG. 2, a plurality of elongated holes 23 disposed one after the other in a row in the conveying direction F are disposed in the conveyor tray floor 19. The control device 30 can now be implemented such that one measurement interval is triggered for each penetration 23 displaced through the measuring beam path 52. There are thus a plurality of successive measurement intervals during the delivery time window. The delivering of the conveyed good 60 can thus be monitored by the sensor device 50 over the duration of the delivery time window.

Alternatively, the penetrations 23, i.e. the openings or the holes, can also be disposed in a central region of the conveyor tray floor 19. In this case, failure to cover the penetrations 23 would indicate delivering of the conveyed good 60, while covering the penetrations 23 would indicate a lack of delivering. In this case, the sensor unit 51 would be disposed closer to the end of the delivery station 4 or after the same along the conveyor track 2.

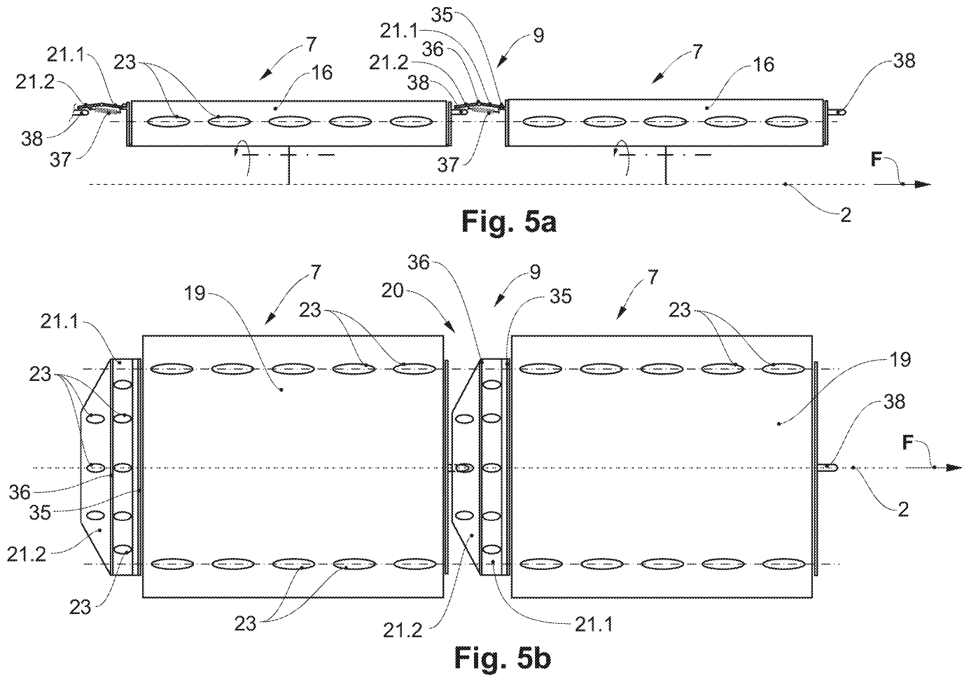

FIGS. 5a and 5b show conveyor trays 7 having a covering device 20 for covering the intermediate space 9 between two successive conveyor trays 7.

The covering device 20 is implemented as multiple parts and includes a first and second cover plate element 21.1, 21.2 connected to the rear bounding wall 18 of the conveyor tray 7 by a hinge 35. The second cover plate element 21.2 is connected to the first cover plate element 21.1 by a further hinge 36. The cover device 20 is supported on a support mandrel 38 on which the second cover plate element 21.2 is displaceably supported. The support mandrel 38 is disposed, i.e. arranged at the front bounding wall 17 of the following conveyor tray 7.

The cover elements 21.1, 21.2 can alternatively also be connected to the front bounding wall 17 by a hinge and the support mandrel 38 can be disposed on the rear bounding wall 18.

The two first and second cover plate elements 21.1, 21.2 are further connected to each other across the hinges by a return spring 37 disposed below the plate elements. The return spring 37 exerts a return force on the two plate elements 21.1, 21.2, holding down the cover plate elements 21.1, 21.2.

In case of relative motions between two successive conveyor units, the cover device 20 can slide on the support mandrel 38 or can roll on the support mandrel 38. The support mandrel 38 serves as a support for displaceably supporting the cover device 20. Furthermore, the cover plate elements 21.1, 21.2 can be folded together or compressed by the hinge 36 when the intermediate space 9 is reduced, for example on curved tracks.

The two cover plate elements 21.1, 21.2 include penetrations 23, i.e. holes or openings through which the measuring beam path 52 of a sensor unit 51 disposed, i.e. arranged below the conveyor trays 7, i.e. conveyor units 13 is aimed in a defined measurement interval in an analogous manner to the embodiment examples of FIGS. 3 and 4.

When the cover device 20, i.e. the cover plate elements 21.1, 21.2 thereof are covered by incorrectly placed conveyed good 60 or a foreign object, then said state is registered accordingly by the sensor unit 51, in that the receiver of the sensor unit 51 receives the at least one measuring beam partially reflected by the conveyed good 60 or a foreign object.

When incorrectly placed conveyed good 60 or a foreign object covering the cover device 20 is detected, the operating personnel can be informed of said state by a corresponding warning. The personnel then remove the incorrectly placed conveyed good 60 or foreign object and places the same correctly in the conveyor tray 7.

The conveyor system is preferably stopped and thus placed in a safe operating state until the incorrectly placed conveyed good or foreign object has been removed or discharged.

The measurement method and determining of the measurement intervals follows in an analogous manner to the embodiments described above in conjunction with penetrations 23 in the pivotable side wall 15, 16 or in the conveyor tray floor 19.

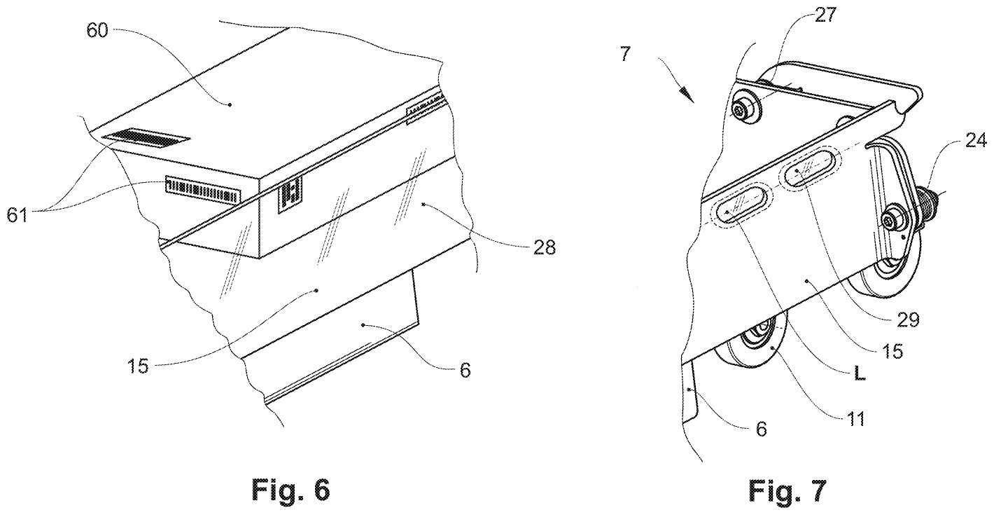

FIG. 6 shows a detail of a further embodiment of a conveyor unit or conveyor tray, wherein the pass-through region 28 is implemented, i.e. formed directly in each case by the pivotable side walls 15, 16, said walls being made of a transparent material such as glass or acrylic glass.

It can also be provided that the conveyor tray floor or the cover device 20 or the cover plate elements 21.1, 21.2 are made of a transparent material such as glass or acrylic glass and thus implement the pass-through region.

FIG. 7 shows a detail of a further embodiment of a conveyor unit or conveyor tray, wherein the pass-through openings are implemented as viewing windows 29. The viewing windows 29 can be made of a transparent material, for example, such as glass or acrylic glass.

The penetrations shown in FIGS. 2 through 5 can also fundamentally be viewing windows.

1. A conveyor system conveying and delivering conveyed goods and comprising a tray conveyor having a plurality of conveyor trays displaceable along a conveyor track, the conveyor trays each comprising at least one conveyor tray element, and comprising at least one sensor device disposed along the conveyor track of the conveyor trays for detecting conveyed goods,
wherein the at least one conveyor tray element comprises at least one pass-through region, and the sensor device is designed and disposed such that a measuring beam path of the sensor device is aimed through the at least one pass-through region on the at least one conveyor tray element in a defined conveying position of the at least one conveyor tray element.

2. The conveyor system according to claim 1, wherein the at least one conveyor tray element is flat in design.

3. The conveyor system according to claim 1, wherein the sensor device is designed for detecting an at least partial covering, by a conveyed good or foreign object, of the at least one pass-through region in the at least one conveyor tray element.

4. The conveyor system according to claim 1, wherein the at least one pass-through region is a pass-through opening in the conveyor tray element.

5. The conveyor system according to claim 4, wherein the at least one pass-through opening is a viewing window or a passage hole.

6. The conveyor system according to claim 4, wherein the at least one pass-through opening is elongated in design, and the longitudinal axis of the pass-through opening is aligned particularly parallel to the conveying direction.

7. The conveyor system according to claim 1, wherein the sensor device comprises at least one sensor unit, particularly at least one optoelectronic sensor unit, such as a laser sensor unit.

8. The conveyor system according to claim 7, wherein the sensor device comprises a plurality of sensor units spaced apart from each other, particularly a plurality of optoelectronic sensor units, such as laser sensor units, the measuring beam paths thereof being disposed:
successively in the conveying direction, and/or
successively transverse to the conveying direction.

9. The conveyor system according to claim 1, wherein the conveyor tray forms a receiving space for receiving a conveyed good and the at least one conveyor tray element is a pivotable side wall bounding the receiving space.

10. The conveyor system according to claim 9, wherein the conveyor system comprises at least one delivery station disposed along the conveyor track for delivering a conveyed good from the conveyor tray, and the sensor device is disposed such that a measuring beam path of the sensor device is aimed through the at least one pass-through region of the side wall of the conveyor tray pivoted down for delivering the conveyed good at the delivery station in a measurement interval at the delivery station.

11. The conveyor system according to claim 9, wherein the sensor device is designed for detecting an at least partial covering, by a conveyed good, of the at least one pass-through region of the side wall pivoted down at the delivery station, particularly a temporary covering by a conveyed good sliding down to the delivery station from the conveyor tray across the side wall pivoted down.

12. The conveyor system according to claim 1, wherein the at least one conveyor tray element forms the conveyor tray floor of the conveyor tray.

13. The conveyor system according to claim 12, wherein the sensor device is designed for detecting a covering, by a conveyed good present on the conveyor tray, of the at least one pass-through region in the conveyor tray floor.

14. The conveyor system according to claim 1, wherein the at least one conveyor tray element forms a cover element of a cover device for at least partially covering an intermediate space between two conveyor trays adjacent to each other along the conveyor track.

15. The conveyor system according to claim 14, wherein the sensor device is designed for detecting a covering, by a misplaced conveyed good or foreign object, of the measuring beam path leading through the at least one pass-through region in the cover element.

16. A method for detecting conveyed goods conveyed by means of a conveyor system according to claim 1, wherein a measuring beam of the sensor device is aimed through the at least one pass-through region on the at least one conveyor tray element in a defined conveying position of the at least one conveyor tray element, and detects a covering, by a conveyed good, of the measuring beam path leading through the pass-through region.

17. The method according to claim 16, wherein the sensor device comprises an optoelectronic sensor unit by means of which the reflection of the measuring beam at the conveyed good at least partially covering the at least one pass-through region is detected.

18. The method according to claim 16, wherein the sensor device determines whether a conveyed good at the delivery station has slid down from the conveyor tray to the delivery station across the side wall pivoted downward.

19. The method according to claim 16, wherein measuring beams of a plurality of sensor units are each aimed through a pass-through region in the side wall pivoted down, by means of which the sliding behavior, such as the sliding speed, of the conveyed good is determined.

20. The method according to claim 16, wherein measurement intervals are matched to the conveying motion or to the conveying cycle of the conveyor trays, wherein the measurement intervals each take place synchronously with the motion of the at least one pass-through region, in particular pass-through opening, through the measuring beam path of the sensor device.
